(19) United States
(12) Patent Application Publication
(10) Pub. No.: US 2010/0150172 A1
(43) Pub. Date: Jun. 17, 2010

(54) DYNAMIC POWER LINE BANDWIDTH LIMIT

(75) Inventors: Yeshayahu ZALITZKY, RaAnana (IL); David Hadas, Zikhron-Yaakov (IL)

Correspondence Address: MARTIN D. MOYNIHAN d/b/a PRTSI, INC., P.O. BOX 16446, ARLINGTON, VA, 22215, US

(73) Assignee: Main.Net Communications Ltd., RaAnana (IL)

(21) Appl. No.: 12/626,676

(22) Filed: Nov. 26, 2009

Related U.S. Application Data
(63) Continuation of application No. 10/641,241, filed on Aug. 13, 2003, now abandoned.
Application No. 10/641,241 is a continuation of application No. PCT/IL2003/000546, filed on Jun. 29, 2003.

(51) Int. Cl. H04J 3/22

(52) U.S. Cl. 370/468

(57) ABSTRACT

A method of dynamically controlling a maximal bandwidth limit of one or more clients in a network connecting the clients to a remote point through a plurality of nodes. The method includes monitoring one or more parameters of the traffic through a first node of the network, determining whether the value of the one or more monitored parameters fulfills a predetermined condition, changing the maximal bandwidth limit of one or more clients of the network, responsive to a determination that the value of the one or more parameters fulfills the condition and imposing the maximal bandwidth on the one or more clients by a second node of the network different from the first node.

### RELATED APPLICATIONS

This application is a continuation of U.S. patent application Ser. No. 10/641,241 filed Aug. 13, 2003, which is a continuation of PCT Patent Application No. PCT/IL2003/000546 filed on Jun. 29, 2003. The contents of the above applications are incorporated herein by reference.

### FIELD OF THE INVENTION

The present invention relates to signal transmission over power lines.

### BACKGROUND OF THE INVENTION

Electric power lines can be used to access external (backbone) communication networks, such as the Internet. For example, EP patent publication 0 975 097, the disclosure of which is incorporated herein by reference, describes a method of exchanging data between a customer and a service provider over low and medium voltage AC electric power networks.

In implementing such a network, access modems, referred to also as central units (CU), connected to the external communication network, are coupled at one or more points to the power line network. Client modems, referred to also as power line modems (PLM), connect client communication equipment, such as computers, power-line telephones or electrical line control units (e.g., automatic meter readers (AMR), power management and control units), to the power line network, so as to exchange data with one or more of the CUs. In addition to exchanging data with the client modems, the central units may control the supply of data to clients in their vicinity.

The direct transmission distance over electrical power lines between a source (e.g., PLM) and a destination (e.g., CU) is limited due to a relatively high level of noise and attenuation on electrical power lines. The distance, however, may be enhanced by one or more repeaters located between the source and destination. The repeaters may include dedicated repeaters (RP) serving only for repeating messages between other communication units and/or may include other communication equipment, such as CUs and/or PLMs which additionally serve as repeaters. The repeaters generally regenerate the transmitted signals, along the path between the source and the destination. Generally, the repeaters operate at low protocol levels and do not examine higher layer data of the signals they repeat. Operating at low protocol levels only, allows simpler implementation of the repeaters and/or faster repeating operation.

Each device (e.g., PLM, CU, repeater) in the communication power line network has an uplink and downlink bandwidth limit, which is the maximum amount of data that can be transmitted through the link over a specific time. This limit is due to the frequency bands and transmission rates which can be used, which in turn depend on the apparatus implementing the devices and the noise and attenuation levels of the power lines. In addition, each CU has a limit of bandwidth with which it connects to the backbone network. In a service level agreement (SLA) between the client and the service provider running the CUs, each user or client is allotted maximal uplink and downlink bandwidths allowed for transmission by the client. As most users do not use their bandwidth all the time, the allotted bandwidths in the SLAs usually involve overbooking, i.e., add up to levels greater than supported by the communication network. At peak usage times, the clients may request together total bandwidth amounts greater than the network can support. Therefore, one or more of the users may receive lower bandwidth rates than the maximal allowed in their service level agreement. In such cases, one of the PLMs may utilize all the available bandwidth, leaving one or more PLMs starved, i.e., without any bandwidth or with very low bandwidth rates. Reducing the allowed bandwidths in the SLAs to avoid overbooking would solve this problem but would limit the available bandwidth for the PLMs and result in a high percentage of unused bandwidth, on the average.

### SUMMARY OF THE INVENTION

An aspect of some embodiments of the invention relates to dynamically changing the maximal bandwidth allotted to clients in a communication network. In some embodiments of the invention, the maximal bandwidth allotted to clients depends on the utilization rate of the bandwidth of one or more links of the network. Optionally, the maximal bandwidth of each client depends on its location in the network, such that while the bandwidth of one or more first clients of the network is changed, the bandwidth of one or more second clients is unaffected or is changed differently.

In some embodiments of the invention, one or more of the nodes of the network, e.g., CUs, PLMs or repeaters, monitors its load. When the load on the node is very high, the node optionally instructs the PLMs it services to reduce the maximal bandwidth currently allotted to their clients. Optionally, the node identifying the load also instructs its parent node (i.e., the node leading to the CU servicing the node) and/or its neighboring nodes (i.e., the nodes with which the node can communicate directly) to instruct the PLMs they service to reduce the maximal bandwidth currently allotted to their clients. Alternatively or additionally, the node instructs the CU servicing the node to reduce the bandwidth allotted to the clients in the node's vicinity, for example the clients serviced by the node, the node's parent and/or the node's neighbors.

Optionally, when the load on the node is relatively low, the node allows the PLMs to increase the maximal bandwidth allotted to their clients.

In some embodiments of the invention, the dynamic changing of the maximal bandwidth is performed in a network which includes end-units at entrance points to the network connected through internal low-level repeaters, such as in power line networks. The low-level repeaters optionally do not relate to the contents of the packets they repeat, particularly they do not examine the ultimate sources and/or destinations of the packets they repeat. Alternatively or additionally, the repeaters do not manage tables recording the amount of data transmitted by each user of the network.

There is therefore provided in accordance with an exemplary embodiment of the invention a method of dynamically controlling a maximal bandwidth limit of one or more clients in a network connecting the clients to a remote point through a plurality of nodes, comprising monitoring one or more parameters of the traffic through a first node of the network, determining whether the value of the one or more monitored parameters fulfills a predetermined condition, changing the maximal bandwidth limit of one or more clients of the network, responsive to a determination that the value of the one or more parameters fulfills the condition and imposing the maximal bandwidth on the one or more clients by a second node of the network different from the first node.

Optionally, monitoring the one or more parameters comprises monitoring a link condition of at least one link connecting the first node of the network to a neighboring node. Optionally, monitoring the link condition comprises monitoring a noise or attenuation level of the link and/or whether the link is operable. Optionally, monitoring the one or more parameters comprises monitoring a load on the first node of the network. Optionally, monitoring the load on the first node comprises determining the amount of time in which the node is not busy and/or the amount of data the node needs to transmit. Optionally, monitoring the load on the first node comprises determining the available bandwidth of the node.

Optionally, changing the maximal bandwidth limit of one or more clients, responsive to the determination comprises reducing the maximal bandwidth limit of one or more clients responsive to the load on the first node being greater than an upper threshold. Optionally, the upper threshold is lower than a congestion level of the first node. Optionally, reducing the maximal bandwidth limit of one or more clients comprises reducing for fewer than all the clients of the network. Alternatively, reducing the maximal bandwidth limit of one or more clients comprises reducing for a plurality of clients.

Optionally, reducing the maximal bandwidth limit of the plurality of clients comprises reducing for all the clients whose limit is reduced, by a same step size. Optionally, reducing the maximal bandwidth limit of the plurality of clients comprises reducing for all the clients whose limit is reduced, to a same percentage of respective base maximal bandwidth limits.

Optionally, reducing the maximal bandwidth limit of the plurality of clients comprises reducing for different clients by different step sizes. Optionally, reducing by different step sizes comprises reducing for each client by a step size which is a function of a respective base maximal bandwidth limit of the client. Optionally, reducing the maximal bandwidth limit of one or more clients comprises reducing for clients in the vicinity of a node having a load above the upper threshold. Optionally, reducing the maximal bandwidth limit of one or more clients comprises reducing for clients serviced by the node having a load above the upper threshold or by any direct neighbor of the node having a load above the upper threshold.

Optionally, transmission of signals by the first node prevents at least one node other than a node receiving the signals from transmitting or receiving signals concurrently. Optionally, imposing the maximal bandwidth on the one or more clients comprises imposing on one or more clients that did not transmit signals that affected the throughput of the first node. Optionally, the monitoring of the one or more parameters is performed by the one or more first nodes, which determine when the predetermined condition is fulfilled. Optionally, the one or more first nodes transmit their determination to the second node. Optionally, the message from the first node is transmitted to the second node over the network. Optionally, the first node comprises a repeater. Optionally, the repeater does not examine the original source and original destination fields of the messages it repeats. Optionally, the second node comprises an entrance unit of the network. Optionally, the network comprises a cell based network, such as a wireless LAN network. Alternatively or additionally, the network comprises a power line network. Optionally, the network comprises an access network. Optionally, changing the maximal bandwidth of one or more clients comprises changing both the uplink and downlink limits for the client.

In some embodiments of the invention, changing both the uplink and downlink limits for the client comprises changing the uplink and downlink according to different rules. Alternatively or additionally, changing the maximal bandwidth of one or more clients comprises changing only one of the uplink and downlink limits of the client. Optionally, imposing the maximal bandwidth on the one or more clients comprises discarding data of the one or more clients exceeding their respective maximal bandwidth limit. Optionally, imposing the maximal bandwidth on the one or more clients comprises delaying the data of the one or more clients so that the data is forwarded from the second node at a rate lower than or equal to the respective maximal bandwidth limit of the client. Optionally, the first node cannot transmit while receiving signals from a neighboring node.

There is therefore provided in accordance with an exemplary embodiment of the invention a communication unit, comprising an input interface adapted to receive data for transmission, an output interface adapted to forward data received by the input interface, a controller adapted to determine a dynamic bandwidth limit for at least one client responsive to information on a parameter of the traffic through a different unit of a network in which the communication unit operates and a data processor adapted to impose the dynamic bandwidth limit on the data received by the input interface.

Optionally, the information on the parameter is received from a different unit of the network, through the input interface. Optionally, the information on the parameter comprises information on the load of the different unit. Optionally, the controller is adapted to reduce the dynamic bandwidth limit of at least one client responsive to a determination that at least one unit of the network has a load above a predetermined threshold. Optionally, the predetermined threshold is below a congestion level of the node.

### BRIEF DESCRIPTION OF THE DRAWINGS

Particular non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a power line network suitable for implementing dynamic bandwidth limitation, according to an exemplary embodiment of the invention;

FIG. 2 is a schematic illustration of a power line network topology, useful in explaining an exemplary embodiment of the invention;

FIG. 3 is a flow diagram of a method of dynamically limiting bandwidth usage according to an exemplary embodiment of the invention; and

FIG. 4 is a schematic illustration of a network topology used to explain an exemplary dynamic limitation of client maximal bandwidth limits, in accordance with an embodiment of the invention.

### DETAILED DESCRIPTION OF EXEMPLARY EMBODIMENTS

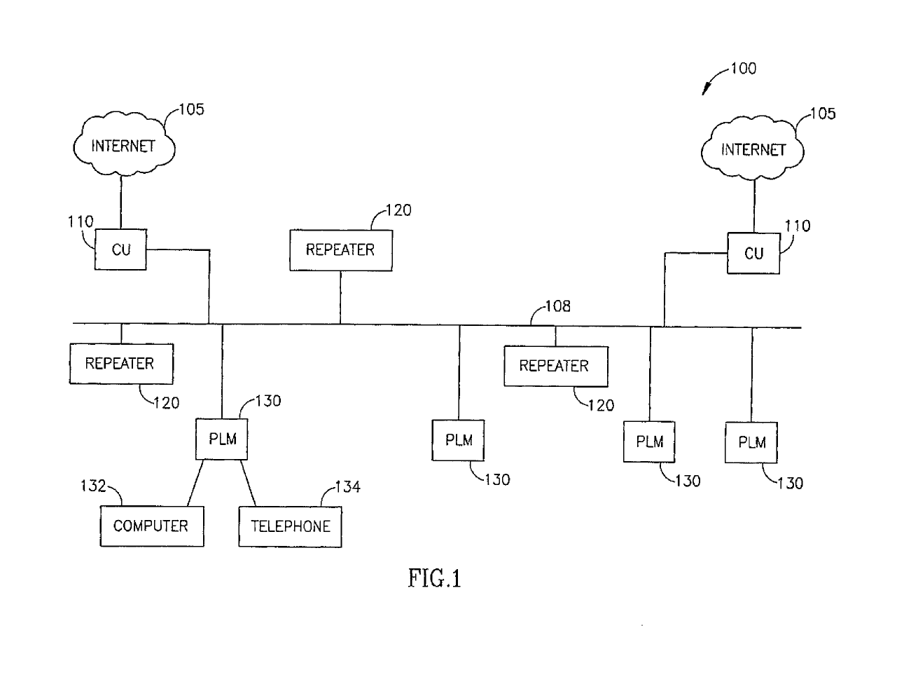

FIG. 1 is a schematic illustration of a power line data transmission network 100 suitable for illustrating exemplary embodiments of the invention. Network 100 provides data transfer capabilities over an electric power line 108. The use of power line 108 for data transfer substantially reduces the cost of installing communication cables, which is one of the major costs in providing communication services. Network 100 optionally includes one or more control units (CUs) 110, distributed throughout a serviced area, for example a CU 110 for each building, block or neighborhood. The CUs 110 interface between an external data network, such as a packet based network (e.g., Internet 105) and power line 108. At client locations, power line modems (PLMs) 130 connect to power line 108, so as to communicate with CUs 110. PLMs 130 may service substantially any communication apparatus, such as a telephone 134, a computer 132 and/or electrical line control units (e.g., automatic meter readers (AMR), power management and control units).

As is known in the art, the noise and attenuation levels on power lines 108 are relatively high. In some embodiments of the invention, in order to overcome the noise and/or attenuation on power lines 108, repeaters 120 are distributed along the power lines. When a PLM 130 is relatively far from a CU 110 that services the PLM, such that signals from CUs 110 are attenuated when they reach the PLM 130, the CU 110 and the PLM 130 communicate through one or more repeaters 120.

Each node (e.g., repeater 120, PLM 130 and/or CU 110) in network 100 can generally communicate with one or more neighboring nodes. The structure of the nodes which can directly communicate with each other is referred to herein as the topology of the network. In some embodiments of the invention, the nodes may adjust their transmission power in order to control the topology of the network, i.e., which nodes can directly communicate with each other. The control of the transmission power may optionally be performed as described in PCT publication WO 02/15413, the disclosure of which is incorporated herein by reference. In some embodiments of the invention, the topology of network 100 is constant and/or is configured by a human operator. Alternatively, the topology of network 100 varies dynamically, according to the link conditions of the network (for example the noise levels on the power lines) and/or the load on the nodes of the network.

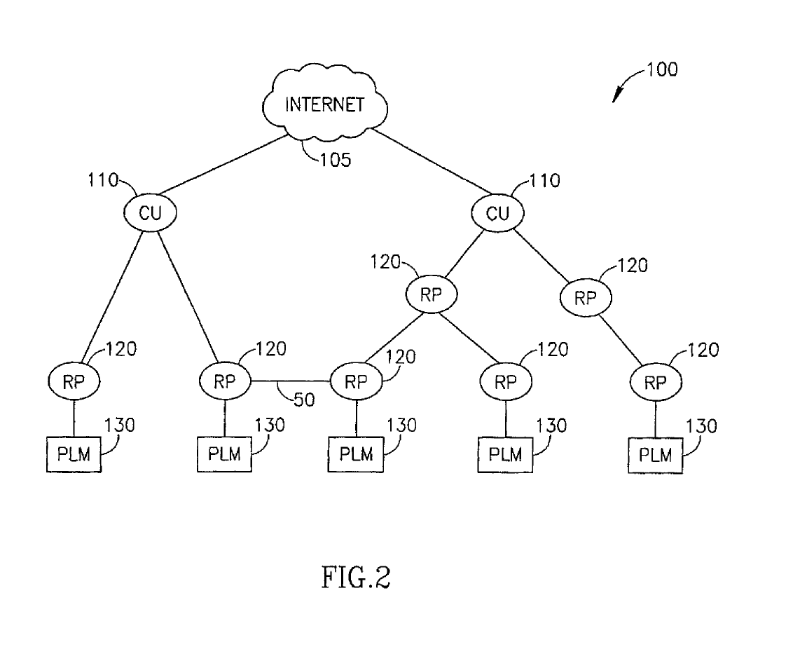

FIG. 2 is a schematic illustration of a power line network topology, useful in explaining an exemplary embodiment of the invention. In FIG. 2, nodes connected by a line are nodes that directly communicate with each other.

In some embodiments of the invention, each node in network 100 runs a topology determination protocol which determines which nodes can directly communicate with the determining node. Optionally, the topology determination protocol includes periodic transmission of advertisement messages notifying the existence of the node. A node optionally identifies its neighbors as those nodes from which the advertisement messages were received. The topology determination protocol may operate, for example, as described in PCT publication WO 03/010896 and PCT publication WO 03/009083, the disclosures of which are incorporated herein by reference.

Optionally, in some embodiments of the invention, the topology determination protocol also includes, for PLMs 130 and/or RPs 120, determining a CU 110 to service the node. Optionally, a node leading to the determined CU is registered as the parent of the determining node. Alternatively or additionally, neighbors leading from the determining node to a PLM 130 serviced by the CU of the determining node, are registered as child nodes.

In some embodiments of the invention, each PLM 130 has a specific CU 110, which services the PLM. Alternatively or additionally, the CU 110 servicing a specific PLM may change dynamically. The path from PLM 130 to CU 110 may be selected according to physical path cost, for example shortest cable length. Alternatively or additionally, the path from CU 110 to PLM 130 is selected according to a maximum transmission bandwidth. Methods of selection of the path are described for example in the above mentioned PCT publication WO 03/010896.

In some embodiments of the invention, the topology of network 100 is in the form of a tree such that each neighboring node is either a parent node or a child node. Alternatively, some neighboring nodes are neither parents nor children, for example as illustrated in FIG. 2 by link 50.

Each client device (e.g., telephone 134 and/or computer 132) and/or each PLM 130 is optionally allotted a base maximal uplink and downlink bandwidth which it may use. The base maximal bandwidth is optionally set in a service level agreement (SLA) between the client and the service provider. In some embodiments of the invention, the total bandwidth in the SLAs of the clients serviced by network 100 is substantially greater than the physical bandwidth capacity of network 100. The allocating of total maximal bandwidth levels greater than the available physical bandwidth is referred to as overbooking. As most users do not use their bandwidth most of the time, the overbooking allows better utilization of the physical bandwidth of network 100.

In some embodiments of the invention, the base maximal bandwidth limit has a fixed value for each client. Alternatively, the base maximal bandwidth limit varies with the time of day, the date, or any other parameter external to the network. Further alternatively or additionally, the base maximal bandwidth limit varies with the noise level in network 100, with the total load on network 100 and/or with any other parameter of network 100. The total load on network 100 may be determined by one of the CUs receiving reports from some or all of the nodes of the network. Alternatively or additionally, the total load is estimated according to the amount of data received by the CUs of the network and/or the number of TCP connections and/or clients handled by the CUs.

In some embodiments of the invention, all clients have the same maximal bandwidth limits. Alternatively, different clients have different bandwidth limits, for example according to the amount of money they pay for the communication services of network 100.

Each node in network 100 has a maximal bandwidth it can provide, if the node is continuously operative. In some cases, several users may utilize their maximal bandwidth limits and thus utilize the entire bandwidth of one or more nodes of the network. When another user attempts to receive service, the user does not receive service, as one or more of the nodes from which the service is to be received are continuously busy with the other users.

In some embodiments of the invention, PLMs 130 impose a dynamic maximal bandwidth limit on the clients, in order to prevent one or more clients from dominating the bandwidth of the network and thus starving the other clients serviced by the network. In the uplink direction, the dynamic maximal bandwidth limit is optionally imposed by PLM 130, while in the downstream direction the limit is optionally imposed by CU 110. Optionally, in imposing the limit, CUs 110 and/or PLM 130 count the packets and/or bytes of each client (transmitted by or to the client), and when the number of packets and/or bytes of a client exceeds the dynamic maximal bandwidth, additional packets of that client are discarded. In some embodiments of the invention, the dynamic maximal bandwidth of each client is stated as a percentage of the base maximal bandwidth of the client. Alternatively or additionally, the dynamic bandwidth is stated as an absolute number independent from the base limit.

In some embodiments of the invention, each node manages a percentage limit (LIMIT) which states the percentage suggested by the node for limiting the dynamic bandwidth of clients in its neighborhood. In addition, each node optionally manages a dynamic far queue limit (DFL) which it transmits to the PLMs 130 it services. The PLMs 130 optionally use the DFL in calculating the dynamic maximal bandwidth imposed on clients.

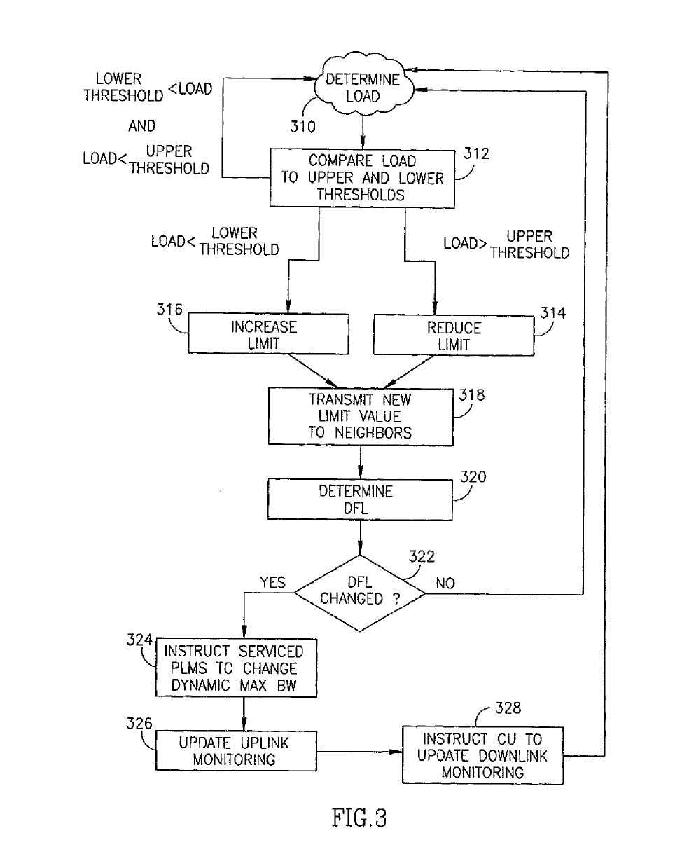

FIG. 3 is a flowchart of acts performed by the nodes of a power line network in adjusting the dynamic maximal bandwidth limit of clients, in accordance with an exemplary embodiment of the invention. Optionally, each node periodically determines (310) its load, for example by determining the time during which the node is busy. A node is optionally considered busy when it is transmitting data, receiving data from another node and/or prevented from transmitting data in order not to interfere with the transmissions of neighboring nodes.

The load on the node is optionally compared to upper and lower thresholds. If (312) the load on the node is above an upper threshold, for example the node is busy over 97% of the time, the node reduces (314) its LIMIT value, in order to prevent one or more of the clients from dominating the bandwidth of network 100. It is noted that, in some embodiments of the invention, the LIMIT is reduced regardless of whether the load on the node is due to a single client or to a plurality of clients. If (312) the load is beneath a lower threshold, the node optionally increases (316) its LIMIT value, in order not to impose unnecessary bandwidth limits. The new (increased or decreased) LIMIT value is optionally transmitted (318) to all the neighbors of the node. If the load is between the lower and upper thresholds, the node optionally continues to determine (310) the load and no other acts are required.

Each node optionally periodically determines (320) a DFL value based on the LIMIT value of the node itself and the LIMIT values received from neighboring nodes. In some embodiments of the invention, the DFL is determined as the minimal LIMIT of the node and its neighbors. Thus, the DFL imposes the strongest limit required in order that none of the nodes will be overloaded. Alternatively, the DFL is calculated as an average of the LIMIT values of the node and its neighbors, optionally a weighted average, for example giving more weight to the LIMIT of the node itself. This alternative generally imposes less harsh bandwidth limitations at the possible cost of slower convergence.

Optionally, if (322) the DFL changed in the periodic determination (320), the node optionally instructs (324) all the PLMs 130 it services to change the dynamic maximal bandwidths of their clients according to the new DFL value. PLMs 130 receiving an instruction to change the dynamic maximal bandwidth of their clients, optionally update (326) their uplink monitoring accordingly. In addition, the PLMs 130 instructed to change the dynamic maximal bandwidth of their clients, optionally instruct (328) the CU 110 from which they receive service to update the downlink monitoring of their clients.

The changed dynamic maximal bandwidth is optionally imposed by data processors of PLM 130 and/or CU 110 which forward the data of the client at a maximal rate imposed by the dynamic maximal bandwidth. Alternatively or additionally, the data processors discard data packets exceeding the maximal bandwidth. In some embodiments of the invention, the change in the maximal bandwidth does not affect the physical bandwidth allocation to the client device or to PLM 130. Thus, the method of the present invention may be used in networks including repeaters in which there is no master unit which controls the bandwidth allocation to all the units.

It is noted that, in some embodiments of the invention, the change in the dynamic maximal bandwidth is performed even when there is no overloaded node. Furthermore, in some embodiments of the invention, the dynamic maximal bandwidth is reduced below a level corresponding to a maximal achievable throughput, in order to allow for additional units to initiate communications without waiting long periods for a free time slot. The method of FIG. 3 is optionally performed repeatedly, the load on the node being periodically monitored. In general, in response to a change in conditions, one or more correction iterations may be performed until the network converges to a relatively stable state. The change in conditions may include, for example, changes in the available bandwidth (for example, due to changes in the noise level), changes in the network topology and/or changes in the bandwidth utilization of the clients. This is indicated by the return line from act 328 to act 310.

Referring in more detail to determining (310) the load on a node, in some embodiments of the invention, the load is determined periodically, for example once every 30-60 seconds. Alternatively, in an attempt to reach faster convergence to a suitable operation load, the load determination is performed at a more rapid rate, for example every 2-5 seconds. The determination is optionally performed by determining the idle time of the node (e.g., time in which the node is not prevented from transmitting by another node and is not itself transmitting) during a predetermined interval (e.g., 1 second). In some embodiments of the invention, in some cases, nodes are required to perform a backoff count before transmitting data. Optionally, time in which the node does not transmit due to a backoff count of the transmission protocol, is included in the idle time. Alternatively, the backoff count time is considered idle time in which the node is not busy.

The upper load threshold is optionally set to a level close to 100% such that the maximal bandwidth of clients is not limited unnecessarily, but not too close to 100% so that a new client attempting to receive service does not need to wait for a long interval before it can transmit a request for service to a CU 110. In an exemplary embodiment of the invention, the upper threshold is set to between about 96-98%. The lower load threshold is optionally set to a level as close as possible to the upper threshold in order to prevent imposing an unnecessary limit on the client's bandwidth. On the other hand, the lower threshold is optionally not set too close to the upper threshold so that changes in the dynamic maximal bandwidth limits do not occur too often. In an exemplary embodiment of the invention, the lower threshold is set to about 90-92% of the maximal possible load. Alternatively or additionally, too often changes in the dynamic maximal bandwidth limits are prevented by setting a minimal rest duration after each change, during which another change is not performed. In accordance with this alternative, a lower threshold of about 95-96% is optionally used.

In some embodiments of the invention, the decision of whether to raise the LIMIT depends on one or more parameters in addition to the comparison of the load to the lower threshold. For example, the decision may depend additionally on the time for which the LIMIT did not change and/or the time of day or date. Optionally, after a long period of time (e.g., a few hours) the LIMIT is raised even if the load is between the lower and upper thresholds. In some embodiments of the invention, the long period of time after which the LIMIT is raised depends on the extent to which the load is above the lower threshold. In some embodiments of the invention, at specific times (e.g., at the beginning of the work day) all LIMITs are set back to 100%. Alternatively or additionally, at specific times of the day when a high usage rate is expected, for example at the beginning of a work day, some or all of the limits are set to rates lower than 100%, e.g., 80%.

Alternatively or additionally to determining the load based on the busy time of the node, in some embodiments of the invention the load is determined based on a comparison of the amount of data the node needs to transmit to the maximal amount of data the node can transmit under current conditions. The maximal amount of data that the node can transmit under current conditions is optionally determined based on the transmission rates between the node and its neighbors and the amount of time in which the node and/or its neighbors are busy due to transmissions from other nodes. The transmission rates of the node to its neighbors optionally depend on the hardware capabilities of the node and its neighbors and the line characteristics (e.g., noise levels, attenuation) along the paths between the node and its neighbors.

In an exemplary embodiment of the invention, in determining the load, each node determines during a predetermined period the amount of data it needs to transmit and the maximal amount of data it could transmit. The amount of data the node needs to transmit is optionally determined as the amount of data the node received for forwarding and the amount of data the node generated for transmission.

Referring in more detail to increasing (316) or reducing (314) the LIMIT, in some embodiments of the invention the changes are performed in predetermined steps. Optionally, all the steps are of the same size, for example 8-10%. Alternatively, steps of different sizes are used according to the current level of the LIMIT. For example, when the LIMIT is relatively high (e.g., 90-100%), large steps of about 10% are optionally used, while when the LIMIT is relatively low smaller steps of about 4-6% are optionally used. Further alternatively or additionally, the size of the step used depends on the time and/or direction of one or more previous changes in the LIMIT. For example, when the current change in the LIMIT is in an opposite direction from the previous change, a step size smaller than the previous step (e.g., half the previous step) is optionally used. Optionally, larger steps are used when the previous change occurred a relatively long time before the current step. Alternatively to using predetermined step sizes, in some embodiments of the invention, the step size is selected at least partially randomly, optionally from within predetermined ranges.

Referring in more detail to transmitting the changed LIMIT to the neighbors of the node, in some embodiments of the invention, the current LIMIT is transmitted periodically to all the neighbors, regardless of whether the value changed. Optionally, the LIMIT is transmitted within the advertisement messages of the topology determination protocol. Alternatively or additionally, when the LIMIT of a node changes, the node transmits the changed value to its neighbors. Optionally, each node stores a table listing for each neighbor the most recent LIMIT received from the neighbor, so that it can be determined whether the changed LIMIT should affect a change in the DFL. Alternatively, each node registers only the neighbor from which the lowest LIMIT was received and optionally the next to lowest LIMIT received.

In accordance with this last alternative, when a notice of a change in the LIMIT is received from a neighbor, the receiving node optionally checks whether the new LIMIT is lower than the minimal LIMIT it has stored. If the new LIMIT is lower than the minimal stored LIMIT, the DFL is updated according to the new LIMIT value. Optionally, the neighbor from which the lowest LIMIT was received is also updated. If, however the new LIMIT is higher than the minimal value, the node determines whether the neighbor node from which the new LIMIT value was received is the node from which the lowest LIMIT was received. If the node from which the new LIMIT value was received is the same as gave the minimal LIMIT value, the DFL is optionally raised to the new LIMIT value or to the stored next to lowest LIMIT value depending on which is lower. In some embodiments of the invention, for simplicity, some or all of the nodes store less data than required for an accurate determination of the DFL. In these embodiments, it may take a longer time to converge to a proper dynamic maximal bandwidth to be imposed on the clients.

Referring in more detail to instructing (324) the PLMs 130 serviced by the node to change the dynamic maximal bandwidths of their clients, in some embodiments of the invention, each node keeps track of its neighbors which are its children. When the dynamic bandwidth is to be changed, the node transmits a bandwidth change message to all the children of the node. Nodes receiving a bandwidth change message optionally forward the message to their children, until all PLMs 130 which are descendants of the node receive the change message. Alternatively or additionally, the node addresses the change message to each of the PLMs 130 serviced by the node. In this alternative, each node optionally determines which PLMs 130 it services, in the topology determination protocol.

In some embodiments of the invention, the change message is not transmitted to the child from which the LIMIT change was received, as this child will generate the change message on its own.

Alternatively or additionally, for example when the topology is controlled by CU 110, instead of instructing PLMs 130 on the change in the DFL of the node, the instructions are transmitted to CU 110. The instructions are optionally transmitted together with an identity of the node that changed the DFL. According to the identity of the node, CU 110 identifies which PLMs 130 are to be affected by the change and accordingly changes the dynamic maximal download bandwidth of the clients of these PLMs 130 and instructs the PLMs to change the dynamic maximal uplink bandwidth.

In some embodiments of the invention, when a PLM receives a plurality of different DFL values from different nodes, the lowest DFL value is used in determining the dynamic bandwidth limits for the clients. Optionally, the dynamic bandwidth limit is determined by applying the DFL to the base maximal bandwidth limit prescribed for the client by the SLA.

For example, a client allowed a maximum of 1 Mbps in the SLA, is limited to 800 kbps when a DFL of 80% is defined.

Alternatively to applying the same DFL to all clients, the DFL is applied with a correction factor depending on one or more parameters of the SLA of the client. In some embodiments of the invention, the correction factor is defined by the SLA of the client. For example, for an additional monthly fee a client may receive priority when network 100 is congested. In such cases, the dynamic maximal bandwidth of clients paying the additional monthly fee is reduced to a lesser extent than of clients not paying the additional fee. In an exemplary embodiment of the invention, the dynamic maximal bandwidth of a client is given by:

Maximal bandwidth=SLA*DFL*(1+0.1(−1)ⁿ)

where n is 1 if the monthly fee is not paid and is 0 if the additional monthly fee is paid. Alternatively or additionally, the correction factor depends on the value of the base maximal bandwidth limit defined by the SLA. Optionally, for a high SLA base maximal bandwidth limit, a correction factor smaller than 1 is used, in order to substantially reduce the bandwidth consumption of large bandwidth users. On the other hand, for a low SLA base maximal bandwidth limit, a correction value greater than 1 is used, as the bandwidth consumption of such clients is anyhow relatively low.

Further alternatively or additionally, the correction factor depends on parameters not related to the SLA of the client, such as the time of day, the day of week and/or the noise levels on the network. Optionally, when the expected usage of the network is relatively high, e.g., during work hours of offices, the correction factor forces sharper decreases of bandwidth. Alternatively or additionally, when the noise level on the network is relatively high, sharper decreases in the bandwidth are forced, as the available bandwidth is lower.

In some embodiments of the invention, PLMs 130 and/or the nodes of network 100 keep track of series of bandwidth changes until convergence is reached and accordingly select LIMIT change steps and/or dynamic maximal bandwidth limit correction factors. For example, a node that finds that in order to reduce its load it changed its LIMIT three times in the same direction may use larger LIMIT change steps the next time it is overloaded. In some embodiments of the invention, for each series of LIMIT changes the node stores the source of the load, e.g., which of the neighbors caused the load, and uses corrected LIMIT change steps according to previous experience when a load due to the same source occurs again. Similarly, in some embodiments of the invention, PLM 130 adjusts the correction factor used according to previous experience.

In some embodiments of the invention, instead of using percentages, the change in the LIMIT is applied in fixed steps of bandwidth. For example, in response to an instruction to reduce the maximal bandwidth of clients, the bandwidth of all the clients may be reduced by a fixed amount (e.g., 50 kbps). This embodiment is optionally used when it is important to provide high bandwidth clients with relatively high bandwidth rates.

In some embodiments of the invention, the same LIMIT value is managed for both the upstream and downstream directions. Alternatively, different LIMIT values are used for the upstream and for the downstream. In some embodiments of the invention, in accordance with this alternative, different step sizes and/or correction factors are used for the different directions and/or different methods of selecting the LIMIT are used. For example, the SLA of a client may state whether the client prefers reduction in bandwidth in the upstream or in the downstream.

In some embodiments of the invention, a client may indicate different importance levels to different services received by the client. For example, telephone services may be considered of high importance while web browsing may be considered of low importance. When the maximal bandwidth of the client is limited, different limits may be applied to the different services. Alternatively or additionally, in dropping excess packets, CU 110 and/or PLM 130 may drop only packets of low priority services, or may give preference to packets of the high priority service.

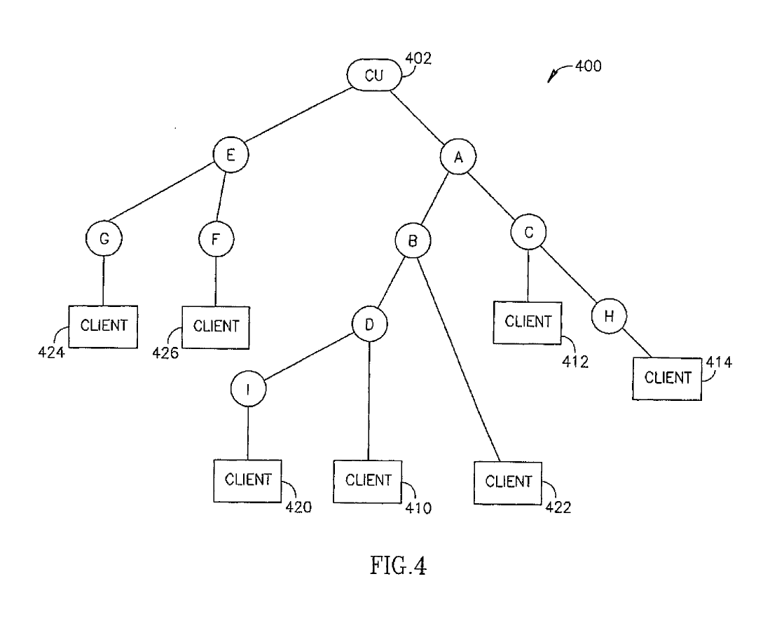

FIG. 4 is a schematic illustration of a network topology 400 used to explain an exemplary dynamic limitation of client maximal bandwidth limits, in accordance with an exemplary embodiment of the invention. Network 400 includes a CU 402 and a plurality of repeaters A, B and E and PLMs C, D, F and G. While one of the nodes transmits data, its direct neighbors are prevented from transmitting. For example, while node B transmits data, nodes A and D listen and cannot transmit to other nodes or receive data from other nodes (transmission by A would prevent B from transmitting). Therefore, if node B is continuously busy, for example, receiving data from node A half the time and forwarding the data to node D in the other half of the time, node A will not be able to communicate with node C as it will always be busy. It is noted, however, that node E will be able to communicate with CU 402 without interruption.

Assuming a client 410 connected to node D has a large base maximal bandwidth limit, allowing it to keep node B continuously busy, if client 410 performs heavy downloads, a client 412 connected to node C will be starved, i.e., will not receive service. When node C will try to transmit data to node A it will generally need to wait long periods of time before receiving permission to transmit data. In accordance with an embodiment of the invention, nodes A, B and D identify that they are continuously busy and lower their LIMIT values. Node B transmits its new LIMIT to its neighbors A and D. Similarly, node A transmits its new LIMIT to nodes A, C and CU 402 and node D transmits its new LIMIT to nodes B and I. Each of the nodes receiving the new LIMIT updates its DFL and instructs the PLMs it services to reduce the dynamic bandwidth limits of their clients accordingly. In this example, all of the PLMs of the network will receive instructions to reduce the dynamic bandwidth limits of the clients. The bandwidth limit reduction of client 410 will reduce the load on nodes A, B and D. If the load goes beneath a lower threshold, the LIMIT of one or more of the nodes will be raised. If the LIMIT is raised by all the nodes, the dynamic limits of the clients will be raised.

The above example is generally very simplistic as in most cases no node will become overloaded due to acts of a single client. A more realistic scenario involves both client 410 and 420 performing heavy downloads concurrently.

In the above description, each overloaded node changes its LIMIT regardless of the load on its neighbors. In other embodiments of the invention, however, before lowering its LIMIT, each node checks whether any of its children is overloaded. If one of the children is overloaded, the node optionally refrains from changing its LIMIT for a predetermined amount of time, allowing the child to handle the problem, as it is assumed that the source of the overload is in clients serviced by the child. In the above example, only node D will reduce its LIMIT, such that only clients 410 and 420 will be limited. In some embodiments of the invention, the parent node lowers its LIMIT only if the child's acts did not remove the overload on the parent after a predetermined amount of time, a predetermined number of LIMIT iterations and/or after a predetermined LIMIT step size. The number of iterations and/or the step size are optionally set such that in case the cause of the load is not only in clients serviced by the child, the bandwidth distribution will not be too unfair, i.e., there will not be a large difference between the percentage of reduction of the different clients in the network.

In some embodiments of the invention, a node checks whether its children are overloaded by transmitting a question to its children nodes and asking them if they are overloaded. Alternatively, each overloaded node notifies its parent that it is overloaded. Optionally, in this alternative, nodes notify their parent that they are overloaded only if the node is not aware of any of its children being overloaded, i.e., the node plans to change its LIMIT. Further alternatively or additionally, a node checks whether any of its children are overloaded by determining whether a LIMIT change is received from one or more of the children.

In another exemplary scenario, client 412 performs a heavy download concurrently with clients 410 and 420 communicating with each other. While node A transmits data to node C, node B will not be able to communicate. In addition, while nodes I and D communicate, node B will be required to remain silent. These transmissions together may cause node B to be overloaded, for example, preventing client 422 from receiving service. Node B will therefore reduce its LIMIT and will notify nodes D and A accordingly. This will cause the PLMs B, C, D, H and I to reduce the dynamic bandwidth limits of the clients they service. The reduction imposed on clients 422 and 414 will have no affect, as these clients are not using the bandwidth anyhow. The bandwidth reduction imposed on clients 410, 412 and 422, however, will reduce the load on node B. It is noted that no limit is imposed on clients 424 and 426 as there is no need for such a limit. Thus, in a single network 400, in which all nodes may communicate with each other over the power lines, different dynamic bandwidth limits are imposed on different clients. It is noted that concurrently with the overload on node B, an overload may be identified by a different node in network 400 causing a different dynamic bandwidth limit being imposed on other areas of the network.

Alternatively to each node in the power line network managing a LIMIT value, PLMs 130 manage the LIMIT values based on information received from the nodes. For example, each node determining that the node is overloaded, transmits a message to all its neighbors notifying that it is overloaded. The neighbors transmit to the PLMs 130 they service a message instructing to reduce the dynamic maximal bandwidth limit of their clients. The PLMs 130 then reduce the dynamic maximal bandwidth limits of the clients, as described above. Optionally, a predetermined time (e.g., 2-5 seconds) after the bandwidth limit is reduced, PLMs 130 do not change the dynamic bandwidth limit again. If after the predetermined time, however, notifications of nodes being overloaded are still received, PLMs 130 again reduce the dynamic bandwidth limits. If after a predetermined interval (e.g., 20-30 seconds) notifications of overloaded nodes are not received, PLMs 130 optionally increase the dynamic bandwidth, so that bandwidth limits are not imposed for too long unnecessarily. In this alternative, the repeaters of network 100 remain relatively simple. In some embodiments of the invention, the extent of the change of the dynamic maximal bandwidth limits depends on the number of nodes complaining to the PLM that they are overloaded. In most cases, the chances that a specific PLM is the major cause of an overload increases with the number of nodes complaining about the overload.

In some embodiments of the invention, for example when network 100 is organized as a tree (e.g., neighbors are either parents or children), rather than LIMIT advertisements and/or overload notifications being transmitted to all the neighbors of the node, the advertisements and/or notifications are transmitted only to the parent of the node. This embodiment reduces the number of nodes which calculate DFLs and transmit instructions to PLMs 130.

Although in the above description the load is monitored by substantially all the nodes of the network, in some embodiments of the invention, the monitoring is performed by fewer than all the nodes of the network. Optionally, an operator may configure the nodes which are to perform load monitoring, for example those nodes which are expected to have higher load levels than other nodes. Alternatively or additionally, only the CUs 110 which are generally expected to have the highest load level in network 100 in many cases, monitor their load.

Alternatively to changing the maximal bandwidth responsive to a high load on a single node of the network, changes in the maximal bandwidth are imposed only when at least a predetermined number of nodes have a high load. Alternatively or additionally, when more nodes are loaded, the extent of the reduction in the maximal bandwidth is increased.

Alternatively to reducing the maximal bandwidth of all the clients serviced by nodes in the vicinity of the loaded node, the maximal bandwidth is reduced only for clients which were actively transmitting or receiving data at the time the high load was identified. In this alternative, only clients who are possibly responsible for the load are limited due to the load, while other clients are unaffected.

It is noted that although the above description relates to a power line access network that provides access to an external network, the principals of the invention may be used also for power line networks that serve only for internal communications between power line modems. In addition, the methods of the present invention may be used in other networks, especially networks in which adjacent nodes use the same physical medium for transmission, so that when one node is transmitting adjacent nodes should remain silent if they use the same time, frequency and code domain. The methods of the present invention are advantageous also for cell based networks, such as wireless local area networks (LANs), in which no single master controls the bandwidth of all the units of the network. Another attribute of some of these networks is that the networks include high level end-units (e.g., client interfaces and external network interfaces) connected through low level repeaters which transmit messages between the cells of the network. In these networks, the cause of the maximal bandwidth limit may be detected in a node (e.g., a low level repeater) different from the node imposing the limit (e.g., a high level end unit). It is noted, however, that in other embodiments of the invention, the maximal bandwidth limit of the client may be imposed by some or all of the repeaters of the network. It is noted that the present invention is especially useful for power line networks, and to some extent also to wireless networks, because of the high levels of noise and attenuation which require a relatively large number of repeaters.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of dynamically controlling a maximal data bandwidth limit of one or more clients in a power line network connecting the clients to a remote point through a plurality of nodes, comprising:
monitoring one or more parameters of the data traffic through a first node, said node connected to the power line network;
determining whether the value of the one or more monitored parameters fulfills a predetermined condition;
changing the maximal data bandwidth limit of one or more clients of the power line network, responsive to a determination that the value of the one or more parameters fulfills the condition; and
imposing the maximal data bandwidth on the one or more clients by a second node, said second node connected to the power line and said second node is different from the first node,
wherein the power line provides data transfer capabilities between the first and second node.

2. A method according to claim 1, wherein monitoring the one or more parameters comprises monitoring a link condition of at least one link connecting the first node of the network to a neighboring node.

3. A method according to claim 2, wherein monitoring the link condition comprises monitoring a noise or attenuation level of the link.

4. A method according to claim 2, wherein monitoring the link condition comprises monitoring whether the link is operable.

5. A method according to claim 1, wherein monitoring the one or more parameters comprises monitoring a load on the first node of the network.

6. A method according to claim 5, wherein monitoring the load on the first node comprises determining the amount of time in which the node is not busy.

7. A method according to claim 5, wherein monitoring the load on the first node comprises determining the amount of data the node needs to transmit.

8. A method according to claim 5, wherein monitoring the load on the first node comprises determining the available bandwidth of the node.

9. A method according to claim 5, wherein changing the maximal bandwidth limit of one or more clients, responsive to the determination comprises reducing the maximal bandwidth limit of one or more clients responsive to the load on the first node being greater than an upper threshold.

10. A method according to claim 9, wherein the upper threshold is lower than a congestion level of the first node.

11. A method according to claim 9, wherein reducing the maximal bandwidth limit of one or more clients comprises reducing for fewer than all the clients of the network.

12. A method according to claim 9, wherein reducing the maximal bandwidth limit of one or more clients comprises reducing for a plurality of clients.

13. A method according to claim 12, wherein reducing the maximal bandwidth limit of the plurality of clients comprises reducing for all the clients whose limit is reduced, by a same step size.

14. A method according to claim 12, wherein reducing the maximal bandwidth limit of the plurality of clients comprises reducing for all the clients whose limit is reduced, to a same percentage of respective base maximal bandwidth limits.

15. A method according to claim 12, wherein reducing the maximal bandwidth limit of the plurality of clients comprises reducing for different clients by different step sizes.

16. A method according to claim 15, wherein reducing by different step sizes comprises reducing for each client by a step size which is a function of a respective base maximal bandwidth limit of the client.

17. A method according to claim 9, wherein reducing the maximal bandwidth limit of one or more clients comprises reducing for clients in the vicinity of a node having a load above the upper threshold.

18. A method according to claim 9, wherein reducing the maximal bandwidth limit of one or more clients comprises reducing for clients serviced by the node having a load above the upper threshold or by any direct neighbor of the node having a load above the upper threshold.

19. A method according to claim 1, wherein transmission of signals by the first node prevents at least one node other than a node receiving the signals from transmitting or receiving signals concurrently.

20. A method according to claim 14, wherein the base maximal bandwidth limit for each client varies with at least one parameter external to the network.

21. A method according to claim 1, wherein transmission of signals from the first node prevents at least one node other than a node receiving the signals from transmitting or receiving signals concurrently.

22. A method according to claim 1, wherein the first node comprises one of a control unit, a power line modem, and a repeater.
